(19) United States
(12) Patent Application Publication
(10) Pub. No.: US 2002/0085830 A1
(43) Pub. Date: Jul. 4, 2002

(54) Recording arrangement having a time/date table for programming a recording

(76) Inventors: Andras Kalmar, Rannersdorf (AT); Hannes Riedl, Vienna (AT)

Correspondence Address: U.S. Philips Corporation, 580 White Plains Road, Tarrytown, NY, 10591, US

(21) Appl. No.: 10/015,483

(22) Filed: Dec. 10, 2001

(30) Foreign Application Priority Data
Dec. 13, 2000 (EP) 00890372.6

(51) Int. Cl. H04N 5/92; H04N 5/781

(52) U.S. Cl. 386/46; 386/125

(57) ABSTRACT

A recording arrangement (1) is adapted to record an information signal (FS) of an information broadcast during a programmed recording time slot (AZ). In order to program the recording time slot (AZ) the recording arrangement (1) can supply OSD information (OSD) in a programming mode of the recording arrangement (1), which information can be displayed by means of a television set (9) connected to the recording arrangement (1) and includes a time/date table (14; 17). In the time/date table (14; 17) selection time slots (AW) of N minutes are shown, which can be marked as a recording time slot (AZ) by a user, as a result of which the recording arrangement (1) is programmed to record the received information signal (FS).

The invention relates to a recording arrangement for recording an information signal of an information broadcast during a programmed recording time slot.

The invention further relates to a recording method for recording an information signal of an information broadcast during a programmed recording time slot.

Such a recording arrangement and such a recording method are known from the document EP 0 246 392 A2. The known recording arrangement takes the form of a video recorder having recording means for recording a television signal of a programmed television broadcast. With the known video recorder a user can program a so-called timer block in order to record a selected television broadcast that can be received, for example, the next day. For this purpose, the user actuates a preselection key, upon which the user can successively enter the data required to program the recording (television station, recording day, recording start time, recording end time).

The known video recorder is adapted to produce an optical or acoustic warning signal upon completion of the programming of the timer block when the recording time slot defined in the timer block overlaps the recording time slot of a previously programmed timer block. This warning signal is an indication for the user of the video recorder that at least a part of one of the two scheduled recordings cannot be carried through.

It has proved to be a disadvantage of the known video recorder that only after completion of the programming of the timer block the user of the known video recorder receives an indication of the overlap with a timer block already programmed. Moreover, the successive entry of all the data required for programming a timer block is comparatively inconvenient and it is relatively difficult to change data already entered.

It is an object of the invention to provide a recording arrangement of the type defined in the first paragraph and a recording method of the type defined in the second paragraph, with which the aforementioned drawbacks are precluded. In order to achieve this object with such a recording arrangement characteristic features in accordance with the invention are provided, in such a manner that the recording arrangement can be characterized in the manner defined hereinafter.

A recording arrangement for recording an information signal of an information broadcast during a programmed recording time slot, the arrangement having receiving means for receiving the information signal, and having recording means for recording the received information signal on a record carrier, and having display means for supplying OSD information to a display device connectable to the recording arrangement in order to display the OSD information, which OSD information includes programmable selection time slots and/or programmed recording time slots in a two-dimensional graphics display, a first dimension of the two-dimensional graphics display being defined by a time axis and a second dimension of the two-dimensional graphics display being defined by a date axis, and having programming means for receiving user information which identifies at least one selection time slot and for marking this identified selection time slot as a recording time slot, as a result of which the recording arrangement is programmed to record the information signal received in this recording time slot.

In order to achieve said object with such a recording method characteristic features in accordance with the invention are provided, in such a manner that the recording method can be characterized in the manner defined hereinafter.

A recording method for recording an information signal of an information broadcast during a programmed recording time slot, the following steps being carried out: receiving the information signal, recording the received information signal during the programmed recording time slot; supplying OSD information to a display device connectable to the recording arrangement in order to display the OSD information, which OSD information includes programmable selection time slots and/or programmed recording time slots in a two-dimensional graphics display, a first dimension of the two-dimensional graphics display being defined by a time axis and a second dimension of the two-dimensional graphics display being defined by a date axis, receiving user information which identifies at least one displayed selection time slot; marking this identified selection time slot as a recording time slot, as a result of which the recording arrangement is programmed to record the information signal received in this recording time slot.

This has the advantage that in order to program a timer block a time/date table is displayed for the user of the recording arrangement, in which table the user can mark one or more selection time slots by means of a remote control device or keys on the recording arrangement in order to achieve recording of the information signal received in the marked selection time slots. Selection time slots already marked are labeled in a special manner as programmed recording time slots, as a result of which the user will already notice before the programming of a further timer block that the recording time slots of timer blocks will overlap.

The measures defined in claim 2 have the advantage that the station identification information of the information signal to be recorded in a timer block is displayed for the user when the user selects the previously marked recording time slot of this time block with a cursor.

The measures defined in claim 3 have the advantage that a selection time slot defines a given number of N (for example, 1, 3, 5, 30 or 60) minutes and that several of these selection time slots can be marked together as a recording time slot in order to obtain the desired overall recording time.

The measures defined in claim 4 have the advantage that selection time slots and recording time slots of several days can be displayed in a time/date table.

The measures defined in claim 5 have the advantage that the user, for example by actuating a program selection key of the remote control device, can display arbitrary further days of the year in the time/date table and can mark selection time slots as recording time slots on the days thus displayed.

The measures defined in claim 6 have the advantage that after the programming of a timer block the programming means search the program information received by the receiving means for the title of the programmed information broadcast and display this title in the OSD information when the recording time slot of this timer block is selected with the cursor.

The invention will be described in more detail hereinafter with reference to the Figures, which show an embodiment which is given by way of example but to which the invention is not limited.

FIG. 1 shows a hard disk recorder in which selection time slots in a time/data table can be marked as a recording time slot in a programming mode, in order to program the recording of a television signal of a television broadcast.

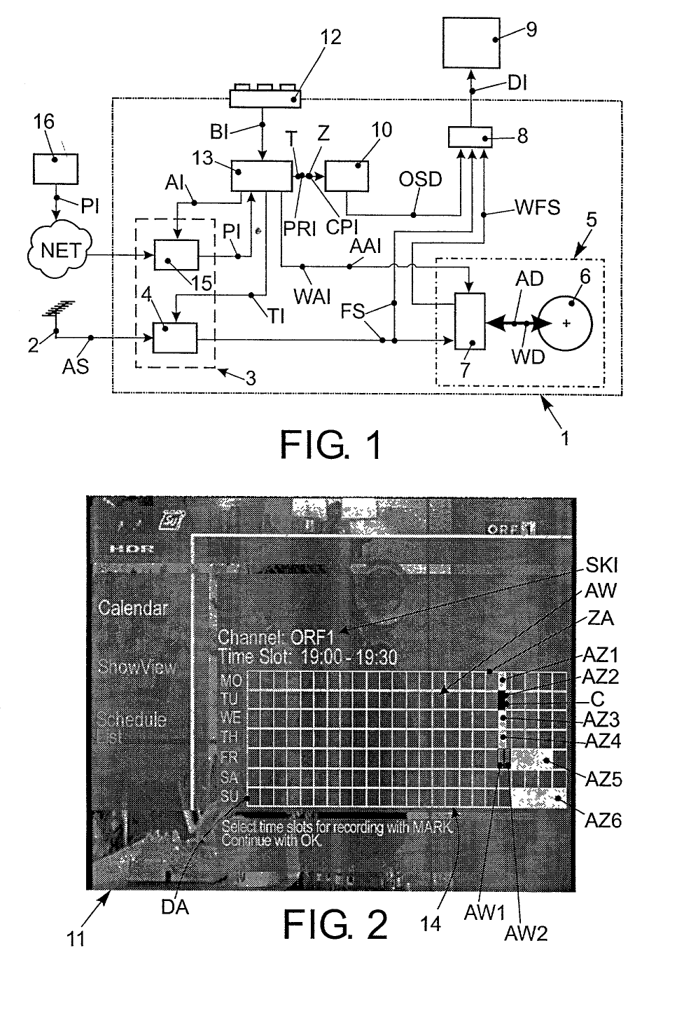

FIG. 2 shows graphics information generated by display means of the hard disk recorder 1 and displayed by a television set connected to the hard disk recorder.

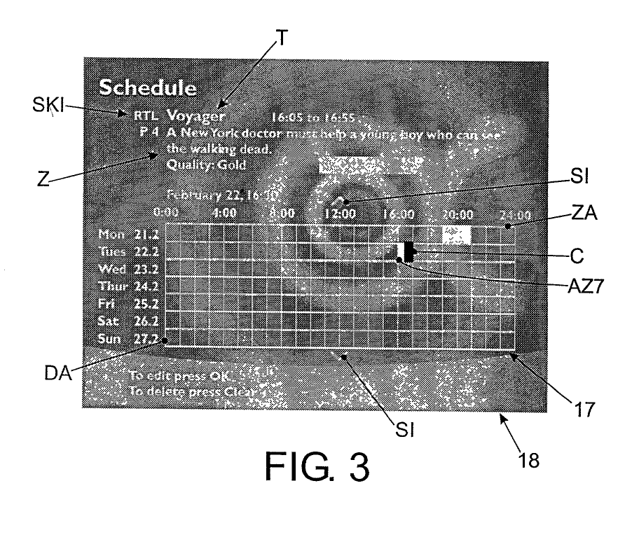

FIG. 3 shows further graphics information which can be generated by the display means of the hard disk recorder 1 and which also includes a time/date table.

FIG. 1 shows a hard disk recorder 1 adapted to record a television signal FS of a television broadcast during a programmed recording time slot AZ. An antenna 2 is connected to the hard disk recorder 1 and can supply an antenna signal AS to receiving means 3 of the hard disk recorder 1.

The receiving means 3 include a tuner 4 by means of which one of a plurality of television signals FS included in the antenna signal AS can be selected. Thus, the television signal FS identified by tuner information TI applied to the tuner 4 is selected from the antenna signal AS.

The hard disk recorder 1 further includes recording means 5 for recording the received television signal FS on a record carrier. For this purpose the recording means 5 include a hard disk 6 and a recording stage 7. In the recording mode of the hard disk recorder 1 recording activation information AAI is applied to the recording stage 7, upon which the received television signal FS is processed by the recording stage 7 and is recorded on the hard disk 6 as recording data AD. The processing of the analog television signal FS in order to obtain digital recording data AD that can be recorded on the hard disk 6 is known to one skilled in the art and is therefore not described in any further detail.

In the recording mode of the hard disk recorder 1 reproduction activation information WAI is supplied to the recording stage 7, upon which the recording stage 7 reads recording data AD recorded on the hard disk 6 as reproduction data WD. The reproduction data WD thus read are processed by the recording stage 7 and are supplied to an output stage 8 of the hard disk recorder 1 as a reproduced television signal WFS.

A television set 9 is connected to the hard disk recorder 1 and forms a display device for displaying display information DI supplied by the hard disk recorder 1. In the reproduction mode of the hard disk recorder 1 the output stage 8 supplies the reproduced television signal WFS to the television set 9 as display information DI and is displayed by the television set 9.

The hard disk recorder 1 further includes an OSD generator 10, which forms display means for the supply of OSD information OSD (On Screen Display) to the output stage 8. In the programming mode of the hard disk recorder 1 the OSD information OSD is superposed on the television signal FS supplied by the tuner and these signals are applied to the television set 9 as display information DI. FIG. 2 shows the display information DI displayed by the television set 9 in the programming mode as graphics information 11.

The hard disk recorder 1 further has a keypad 12 and a controller 13, the controller 13 forming programming means for receiving from the keypad 12 user information BI which identifies at least one of the selection time slots AW and for marking this identified selection time slot AW as a recording time slot AZ. This will be clarified with the aid of the following examples of use of the hard disk recorder 1.

In the first example of use it is assumed that a user of the hard disk recorder 1 wishes to program a so-called timer block on a Monday in order to record a television broadcast to be received in the television signal FS from the television station CNN next Friday from 19:00 hours till 21:00 hours. For this purpose, the user actuates a programming key of the keypad 12, upon which corresponding user information BI is applied from the keypad 12 to the controller 13. Subsequently, the controller 13 activates the programming mode of the hard disk recorder 1 and supplies programming information PRI to the OSD generator 10, upon which the graphics information 11 is displayed on the television set 9.

The graphics information 11 includes a time/data table 14, which in a first dimension of the two-dimensional time/date table 14 is defined by a time axis ZA and in a second dimension of the two-dimensional time/date table 14 is defined by a date axis DA. The time axis ZA is divided into the 24 hours of a day and the date axis is divided into the seven days of a week. The resulting pattern forms selection time slots AW of the current week.

Keys of the keypad 12 now enable user information BI to be applied to the controller 13 in order to position a cursor C, shown as a black area in the graphics information 11, on a desired selection time slot AW within the time/date table 14. Each of the selection time slots AW corresponds to a time interval of 30 minutes of the day indicated on the date axis DA. The controller 13 supplies cursor position information CPI corresponding to the user information BI to the OSD generator 10, which modifies the OSD information OSD supplied to the television set 9 so as to display the cursor C at the position desired by the user.

In the first example of use it is further assumed that for the current week the user has already programmed six other timer blocks for the recording of other television broadcasts, which blocks are identified by marked recording time slots AZ in the time/date table 14. In the present case the user has programmed four timer blocks in order to record the television broadcasts “Zeit im Bild” to be received from the television station ORF 1 from Monday till Thursday from 19:00 hours till 19:30 hours. In the time/date table 14 the corresponding selection time slots are marked as recording time slot AZ1, AZ2, AZ3 and AZ4 (bright areas). A fifth time block for recording the television signal FS of a television broadcast by the television station ZDF on Friday from 20:00 hours till 23:00 hours is displayed as a recording time slot AZ5 and a sixth timer block for recording the television signal FS of a television broadcast by the television station ARD on Sunday from 20:00 hours till 24:00 hours is displayed as a recording time slot AZ6.

This kind of two-dimensional representation of the recording time slots AZ of programmed timer blocks in the time/date table 14 has the advantage that the user has an overview of all the timer blocks already programmed for the current week. With the aid of the recording time slot AZ5 the user is shown directly that the hard disk recorder 1 is already programmed to record the television signal FS from the television station ZDF on Friday from 20:00 hours till 23:00 hours, which will give rise to a time overlap with the recording of the television signal FS from the television station CNN from 19:00 hours till 21:00 hours desired by the user. This has the advantage that already before a new timer block is programmed the user thus detects that an overlap will occur and can make the appropriate changes.

In the first example of use it is now assumed that the user decides that the end of the television broadcast which can be received from the television station CNN is of less interest to him than the beginning of the television broadcast by the television station ZDF already programmed for Friday. Therefore, the user leaves the recording time slot AZ5 unchanged and positions the cursor C on a selection time slot WA1 on Friday from 19:00 hours till 19:30 hours and actuates a marking key of the keypad 12, as a result of which a marking mode of the hard disk recorder 1 is activated.

In the marking mode of the hard disk recorder 1 all the selection time slots AZ of a day on which the cursor is positioned are marked until the marking mode is deactivated. In the first example of use the user activates the marking mode when the cursor C is positioned on the selection time slot AW1. Subsequently, the user positions the cursor on the selection time slot AW2 and then deactivates the marking mode, as a result of which the selection time slots AW1 and AW2 are marked as a recording time slot. Finally, the user actuates a program selection key of the keypad 12 and selects the television signal FS of the television station CNN for recording during the recording time slot on Friday from 19:00 hours till 20:00 hours.

This has the advantage that on the Friday of the current week the television signal FS from the television station CNN is recorded on the hard disk of the hard disk recorder 1 from 19:00 hours till 20:00 hours and the television signal FS from the television station ZDF from 20:00 hours till 23:00 hours. Thus, it is never possible to program overlapping timer blocks whose processing in prior-art recording arrangements regularly leads to conflicts.

By actuating the keys of the keypad in the programming mode of the hard disk recorder 1 the user can now position the cursor C on recording time slots AZ already marked for recording, upon which station identification information SKI is displayed, which identifies the television station of the television signal FS to be recorded in the present recording time slot AZ. This has the advantage that upon selection of one of the recording time slots shown in the time/date table 14 all the data of this timer block are displayed for the user and the user can check whether said data are correct.

The receiving means 3 of the hard disk recorder 1 now in addition include an interface 15 adapted to process the TCP/IP protocol and thus retrieve information from the internet NET. After deactivation of the marking mode for marking a recording time slot AZ the controller 13 supplies an address information Al to the interface 15, which information contains the internet address of an EPG server 16 connected to the Internet NET. The EPG server 16 stores program information PI of television broadcasts scheduled by a multitude of television stations in the current week.

When the address information AI is received the interface 15 now retrieves the program information PI stored in the EPG server 16 for the television broadcast being programmed. The program information PI thus retrieved includes the title T of the television broadcast, the broadcast start time, the broadcast end time, the VPS code of the television broadcast and a summary Z of the television broadcast. The program information PI received by the interface 15 is applied from the interface 15 to the controller 13, which determines the title T and the summary Z of the television broadcast FS being programmed and inserts it into the OSD information.

FIG. 3 shows another method of displaying a time/date table 17 in graphics information 18 displayed by means of the television set 9. The title T and the summary Z of the programmed television broadcast programmed in the recording time slot AZ7, which are derived from the program information PI by the controller 13, are displayed in the graphics information 18.

This has the advantage that, although the user has simply marked given selection time slots AW as the recording time slot AZ7, the title and the summary of television broadcast to be received in the future from the television station RTL in this recording time slot AZ7 are displayed for the user. Thus, the user need not be familiar with the often relatively complicated programming methods of known recording arrangements based on an Electronic Program Guide and yet has the advantage of the additional program information PI.

As is indicated by scroll information SI in the graphics information 18, the user can actuate keys of the keypad to select an arbitrary week of the year for display in order to mark a selection time slot in this selected week as a recording time slot. This has the advantage that the user can program timer blocks for the recording of television broadcasts several weeks and months in advance.

It is to be noted that a recording arrangement in accordance with the invention may be adapted to record on the following other record carriers:

magnetic tape, optical storage media, magneto-optical storage media, read-only memories.

It is to be noted that the time/date table in the displayed graphics information may have a data axis DA with only one, two, three but also 20 days. Neither is it necessary that all the 24 hours of the time axis ZA of a day must be visible in the graphics information. Portions of the time axis may be displayed through a scroll function.

It is to be noted that the recording arrangement may also be adapted to record an information signal including only audio information (music, speech, ...).

It is to be noted that program information may also be derived from the received information signal (for example, a television signal including teletext).

It is to be noted that marking of selection time slots may be effected in a multitude of different ways. For example, the marked selection time slot may also be used to display the station identification information SKI or the title TI of the television broadcast to be recorded.

1. A recording arrangement (1) for recording an information signal (FS) of an information broadcast during a programmed recording time slot (AZ), the arrangement having
receiving means (3) for receiving the information signal (FS), and having
recording means (5) for recording the received information signal (FS) on a record carrier (6), and having
display means (10) for supplying OSD information (OSD) to a display device (9) connectable to the recording arrangement (1) in order to display the OSD information (OSD), which OSD information (OSD) includes programmable selection time slots (AW) and/or programmed recording time slots (AZ) in a two-dimensional graphics display (11; 18), a first dimension of the two-dimensional graphics display (11; 18) being defined by a time axis (ZA) and a second dimension of the two-dimensional graphics display (11; 18) being defined by a date axis (DA), and having
programming means (13) for receiving user information (BI) which identifies at least one selection time slot (AW) and for marking this identified selection time slot (AW) as a recording time slot (AZ), as a result of which the recording arrangement (1) is programmed to record the information signal (FS) received in this recording time slot (AZ).

2. A recording arrangement (1) as claimed in claim 1, in which the programming means (13) are adapted to define the information signal (FS) identified by received user information (BI) as the information signal (FS) to be received by the receiving means (3) during the recording time slot (AZ) and in which the display means (10) are adapted to insert station identification information (SKI) identifying the defined information signal (FS) into the OSD information (OSD) when this recording time slot (AZ) in the displayed OSD information (OSWD) is selected.

3. A recording arrangement (1) as claimed in claim 1, in which one or more of the displayed selection time slots (AW) can be marked as a recording time slot (AZ) by the programming means (13), each selection time slot (AW) identifying a time interval of N minutes of the day indicated in the second dimension (DA).

4. A recording arrangement (1) as claimed in claim 1, in which the OSD information (OSD) supplied by the display means (10) includes a time axis (ZA) defining 24 hours and a date axis (DA) defining M successive days.

5. A recording arrangement (1) as claimed in claim 4, in which the programming means (13) enable user information (BI) to be received, by means of which user information M arbitrary successive days of the year can be selected for the date axis (DA) and can be displayed as OSD information (OSD).

6. A recording arrangement (1) as claimed in claim 1, in which the receiving means (3) are adapted to receive program information (PI),and in which the programming means (13) are adapted to derive a title (T) of a programmed information broadcast from the received program information (PI), and in which the display means (10) are adapted to insert the derived title (T) into the OSD information (OSD).

7. A recording method for recording an information signal (FS) of an information broadcast during a programmed recording time slot (AZ), the following steps being carried out:
receiving the information signal (FS),
recording the received information signal (FS) during the programmed recording time slot (AZ);
supplying OSD information (OSD) to a display device (9) connectable to the recording arrangement (1) in order to display the OSD information (OSD), which OSD information (OSD) includes programmable selection time slots (AW) and/or programmed recording time slots (AZ) in a two-dimensional graphics display (11; 18), a first dimension of the two-dimensional graphics display (11; 18) being defined by a time axis (ZA) and a second dimension of the two-dimensional graphics display (11; 18) being defined by a date axis (DA),
receiving user information (BI) which identifies at least one displayed selection time slot (AW); marking this identified selection time slot (AW) as a recording time slot (AZ), as a result of which the recording arrangement (1) is programmed to record the information signal (FS) received in this recording time slot (AZ).

8. A recording method as claimed in claim 7, in which the following further step is carried out:
marking one or more of the displayed selection time slots (AW) as a recording time slot (AZ), each selection time slot (AW) identifying a time interval of N minutes of the day indicated in the second dimension ( DA).
